(19) United States
(12) Patent Application Publication
(10) Pub. No.: US 2023/0032450 A1
(43) Pub. Date: Feb. 2, 2023

(54) METHODS AND SYSTEMS FOR COMMUNICATING ACROSS MULTIPLE PROCUREMENT PLATFORMS

(71) Applicant: Ricky Nariani, Los Angeles, CA (US)

(72) Inventor: Ricky Nariani, Los Angeles, CA (US)

(21) Appl. No.: 17/963,420

(22) Filed: Oct. 11, 2022

Related U.S. Application Data
(62) Division of application No. 17/153,286, filed on Jan. 20, 2021, now abandoned.
(60) Provisional application No. 63/125,069, filed on Dec. 14, 2020.

(51) Int. Cl. G06Q 30/08; G06Q 10/08; G06Q 30/06

(52) U.S. Cl. CPC G06Q 30/08; G06Q 10/087; G06Q 30/0623

(57) ABSTRACT

A method and system for communicating with a plurality of platform computing systems. The method receives, at a processing system, a request to procure a product or sell a product such as sneakers, clothing or other collectables. The request specifying a variation of the product such as year of manufacture and or price. The system or method then transmits, by the processing system, a bid or offer request to one or more additional platform computing systems for the product having the specified variation. After receiving an indication of an accepted bid or offer corresponding to the bid request from one of the platforms, the system or method transmits to the remaining platform computing systems, a cancellation request for the bid request thereby preventing a conflicting sale or purchase.

This application is a divisional of U.S. application Ser. No. 17/153,286 filed Jan. 1, 2021, for “METHODS AND SYSTEMS FOR COMMUNICATING ACROSS MULTIPLE PROCUREMENT PLATFORMS,” which in turn claims the benefit of U.S. Provisional Application No. 63/125,069 filed Dec. 14, 2020, for “METHODS AND SYSTEMS FOR COMMUNICATING ACROSS MULTIPLE PROCUREMENT PLATFORMS” are hereby incorporated by reference in their entirety.

### BACKGROUND

The disclosed invention relates generally to the field of asset management systems. More specifically, the disclosed invention relates to facilitating communication between one or more platform computing systems.

A platform computing system may be associated with a particular platform for the purchase and sale of various goods, services, or products. A platform may be associated with a particular company or vendor, or may be structured as a marketplace in which individuals may list their own goods, services, or products for purchase by other individuals or companies via the platform. Automated procurement systems may be used to initiate and facilitate the online purchase of a good, service, or product provided by a platform at a designated price.

### BRIEF DESCRIPTION OF THE DRAWINGS

Various aspects of the present disclosure may be better understood upon reading the following detailed description and upon reference to the drawings, in which:

FIG. 1 depicts a block diagram of a procurement system with multiple platform computing systems, according to one embodiment;

FIG. 2A illustrates data elements in an aggregation of product data across multiple platforms, according to one embodiment;

FIG. 2B depicts a flow diagram for a method for integrating two platform computing systems, according to one embodiment;

FIG. 3 depicts a flow diagram of a method for initiating procurement of a product from one of multiple platforms, according to one embodiment;

FIG. 4A depicts another flow diagram of a method for interacting with a user device in initiating procurement of a product, according to one embodiment;

FIG. 4B depicts a flow diagram of a method for implementing multiple bid requests for a procurement request, according to one embodiment.

FIG. 5 depicts a flow diagram of a method for communicating between multiple platforms to list a product, according to one embodiment;

FIG. 6 depicts another flow diagram of a method for communicating between multiple platforms to list a product, according to one embodiment;

FIG. 7 depicts a flow diagram for determining a threshold procurement value for a product, according to one embodiment;

FIG. 8 illustrates an example graphical user interface for a product display, according to one embodiment;

FIGS. 9A and 9B illustrate an example graphical user interface for an inventory list, according to one embodiment; and

FIGS. 10A and 10B illustrate another example graphical user interface for procurement management, according to one embodiment.

### DETAILED DESCRIPTION

The present disclosure is directed to systems and methods for communicating between one or more platform computing systems and an end user. As discussed herein, the one or more platform computing systems offer or otherwise make available for purchase product assets to individuals or entities. The platforms may directly sell the product assets or provide a marketplace for third-party entities to sell the product assets to other platform users. The platforms may implemented via online media (including, but not limited to, a website, mobile application, or third-party platform) or in an offline setting (including, but not limited to, in-store purchase, vendor-buyer meet up, special promotion or release, industry fair, etc.).

Product assets may include collectable items, such as sneakers, playing cards, or figurines. Product assets differ from commodities in that they may vary in manufacturer or designer, model, color, size, or condition, and thus be valued differently based on said variations, whereas commodities do not. The different asset variations may also vary in price from each other based on various market and social conditions independently, with positive correlation, or negative correlation. Compared to stock-exchange commodities which can be bought and sold immediately, product assets often must first be physically acquired by the purchaser before being able to be sold again.

Several platforms may exist that sell the same or similar product assets; however, an individual is unable to compare and attain the most valuable purchase or sale of a product across these platforms with expending significant time and resources. Further still, due to the rate of change in price platforms may experience over a relatively short period of time, an optimal price may go unrealized using previous methods of procurement management. Likewise, entities that procure and sell large volumes of inventory lack effective resources to manage their inventories as products are listed and purchased on several platforms.

Automated procurement systems are limited by previous technology in that systems cannot compare opportunities across different platforms. Previous procurement systems have operated solely in isolated platforms because each platform offers or provides fundamentally different assets from the other platforms (for example, the New York Stock Exchange offers U.S. stocks of companies, while the Shanghai Stock Exchange offers Chinese stocks, which may be valued differently than their U.S. issuance). Thus, procurement systems have only operated within a single platform since the offered assets are not comparable across the platforms without liquidizing the asset entirely into a universal or transferable currency. Further still, offered stocks within a stock exchange platform are considered commodities (i.e., valued identically). That is, procurement systems cannot differentiate a product based on variation. There exists a need for an automated procurement system that 1) identifies compatible offerings of a product asset and integrates procurement across several platforms, and 2) improves upon inventory management of procurement across said platforms and variations in said products.

The various embodiments disclosed herein provide several solutions to these and other constraints of current technology via a procurement management and communication system. The disclosed procurement system is configured to communicate with one or more platform computing systems offering a plurality of product assets, identify universal product identifiers for the plurality of product assets, and facilitate the procurement and listing of product assets across the one or more platform computing systems. The procurement system may interact with a user device to facilitate management of the user's product asset inventory across the multiple platforms and improve efficiency. Thus, the present disclosure provides a technical solution of improved communication between isolated platform computing systems and a user for requests relating to a user's inventory. Additionally, the present disclosure provides a technical solution to the current limitations of commodity procurement systems, namely the differentiation and communication of product variations in aggregating platform product data.

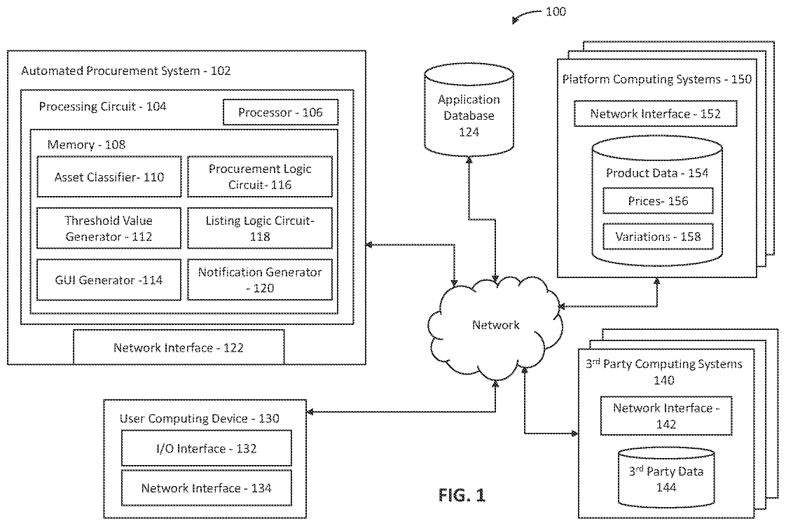

Referring now to FIG. 1, a networked system 100 is shown, according to one embodiment. The networked system 100 includes an automated procurement system 102, application database 124, a user device 130, one or more platform computing systems 150, and one or more third-party computing systems 140. Generally, the automated procurement system 102 interfaces with the user computing device 130 to communicate between the platform computing systems 150 to facilitate procurement management across the platform computing systems 150.

The devices of the networked system 100 may communicate via any combination of wired or wireless connections between network interfaces 122, 134, 142, and 152. The network interfaces 122, 134, 142, and 152 may be direct wired communication connections or a routed network (e.g., LAN, WAN, VPN, the internet, etc.). Likewise, the network interfaces 112, 134, 142, and 152 may include one or more wireless transceivers that implement a communication protocol, such as Bluetooth, Wi-Fi, or cellular connectivity. In some embodiments, some or all of the elements of networked system 100 may be implemented as cloud-based resources with dynamic server allocation.

The automated procurement system 102 comprises a processing circuit 104 that includes one or more processors 106 and a memory 108. The processing circuit 104 may generally be configured to implement various programs, logic, and/or applications stored in memory 108 on the one or more processors 106. The one or more processors may include one or more microprocessors, FPGAs, digital signal processors (DSPs), or any other processing unit, and combinations thereof. The memory 108 may include one or more databases, hard drives, removable memory devices, random-access memory, or any other memory device, and combinations thereof. As would be appreciated, processing circuit 104 may also include or be implemented with other hardware and software elements to facilitate its functionality, including logical gates or hardware and software filters, for example.

The memory 108 is shown to include an asset classifier 110, threshold value generator 112, GUI generator 114, procurement logic circuit 116, listing logic circuit 118, and notification generator 120. The elements of the memory 108 may be implemented as separate hardware circuits or be integrated in various combinations. In some embodiments, the elements of memory 108 are sets of instructions stored in memory 108 and are executed by one or more of the processors 106. In some embodiments, the elements of memory 108 are implemented by separate processing servers.

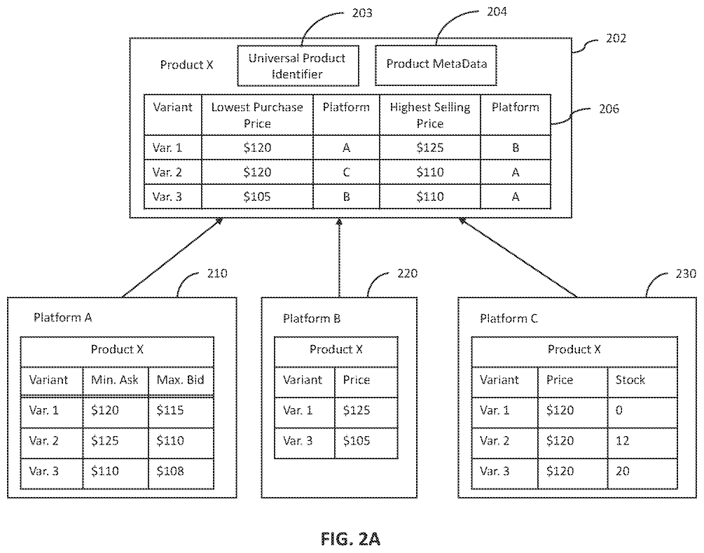

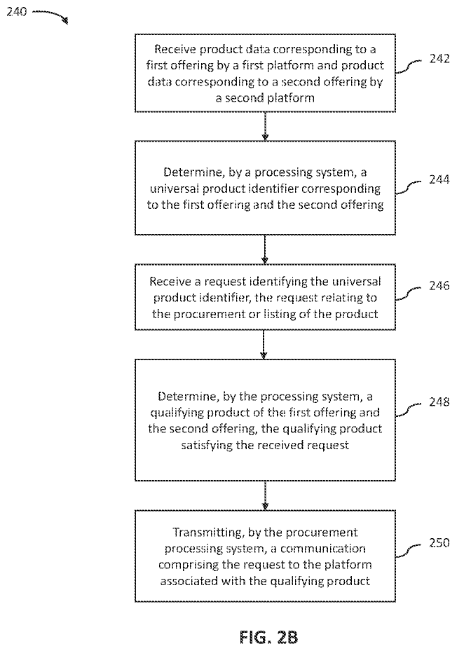

The asset classifier 110 is configured to determine the universal product identifier of offerings from the various platform computing systems 150. The universal product identifier enables comparison of offerings from different platform computing systems 150 that may used different identification or numbering systems to manage their own offerings. The asset classifier 110 may receive product data for one or more products from a platform computing system 150 and determine a universal product identifier for the one or more products. The universal product identifier may be based on an external designation, such as, but not limited to, a manufacturer number, product number, product name, or barcode number, or may be generated and maintained by the procurement system 102. In some embodiments, the asset classifier 110 is configured to generate a new universal product identifier responsive to a determination that a product does not correspond to any stored universal product identifier. In some embodiments, the asset classifier 110 may receive product data from the third-party computing systems 140 to determine or add metadata to storage in relation to the universal product identifier in the application database 124. The asset classifier 110 may also be configured to maintain product data in the application database 124 over time as updates to product data and prices are received from the user computing device 130, platform computing systems 150, and/or third-party computing systems 140. The functionality of the asset classifier 110 will be discussed in further detail below in regard to FIGS. 2A and 2B.

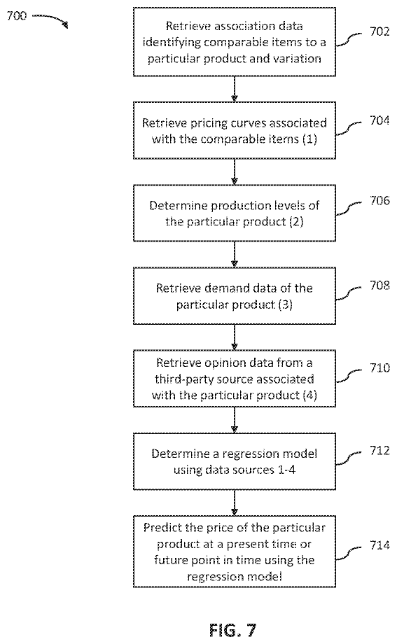

The threshold value generator 112 is configured to determine a threshold procurement or listing value for a product. A threshold procurement value may be used to determine when or if to procure a product from a platform computing system 150 when the price of the product is below the threshold value. In some embodiments, the automated procurement system 102 may generate a notification to the user if the price is above the threshold value. A threshold listing value may likewise be used to determine when or if to list a product on a platform computing system 150. The threshold value generator 112 may use data received from the user computing device 130, platform computing systems 150, and/or third-party computing systems 140 to determine the threshold value. The threshold value generator 112 will be discussed in further detail below in regard to FIG. 7.

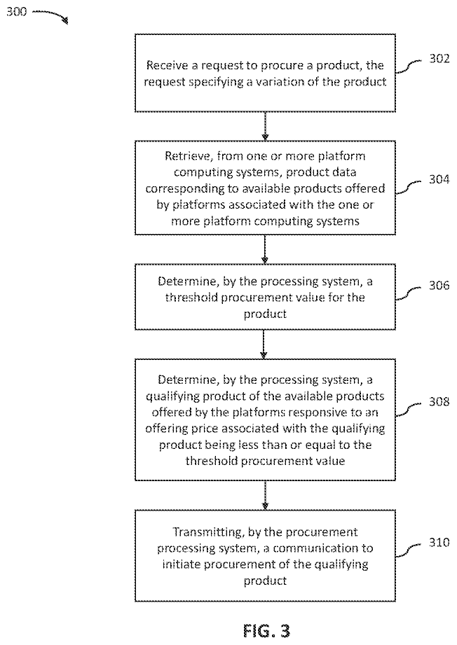

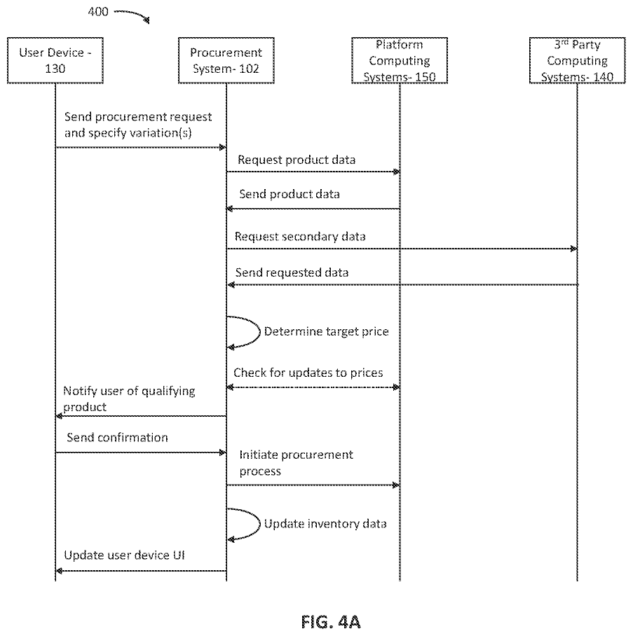

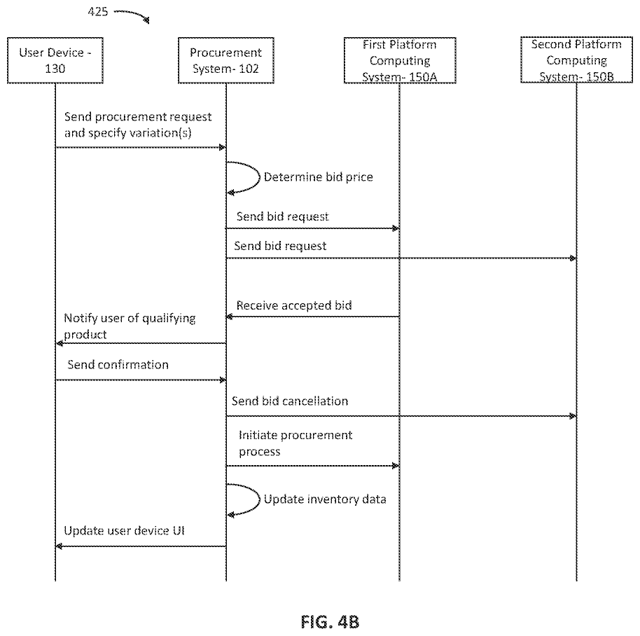

The procurement logic circuit 116 is configured to facilitate communication with the one or more platform computing systems 150 for procurement processes. In some embodiments, the procurement logic circuit 116 is configured to request product data from the platform computing systems 150 for a particular product and determine whether to procure the product based on user input. In some embodiments, the procurement logic circuit 116 is configured to monitor the price of one or more products from multiple platform computing systems 150 over time. In some embodiments, the procurement logic circuit 116 is configured to initiate procurement of a product, such as, but not limited to, sending a bid request or procurement command to the platform computing system 150. The procurement logic circuit 116 may also be configured to respond to accepted bids on product listings and update inventory information accordingly. In one embodiment, the procurement logic circuit 116 is configured to provide a user-selectable link to the user to transfer the user to a website associated with the platform computing system 150, and may transfer additional information to the platform computing system 150 with the link such as user shipping information or payment information. In some embodiments, the procurement logic circuit 116 may generate request to remove bids from platforms with accepted bids responsive to a bid being accepted on a first platform. Procurement configurations associated with the procurement logic circuit 116 will be discussed in subsequent detail below in regard to FIGS. 3 and 4.

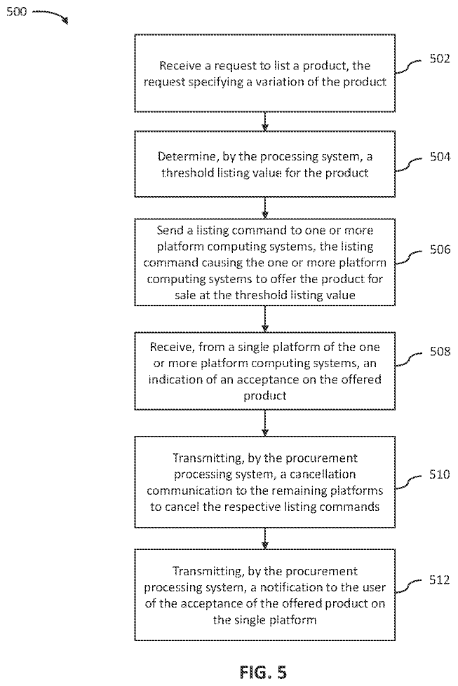

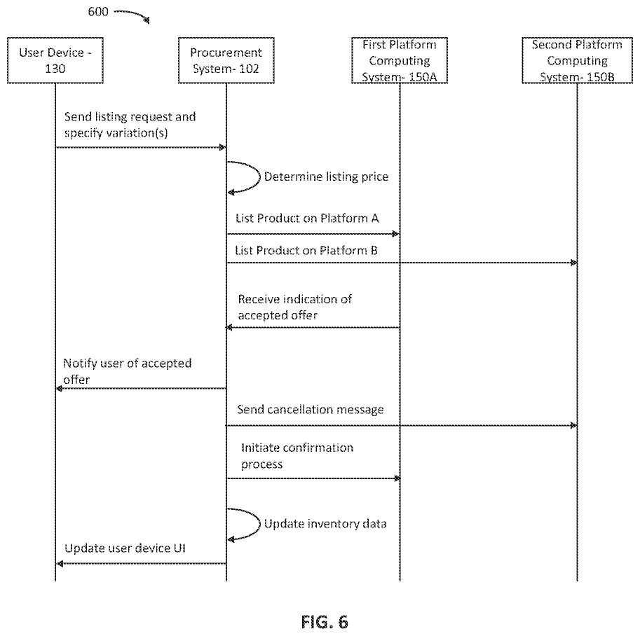

The listing logic circuit 118 is configured to facilitate communication with the one or more platform computing systems 150 for listing or offering processes. In some embodiments, the listing logic circuit 118 is configured to request product data from the platform computing systems 150 for a particular product and determine whether to list the product and which platform to list the product based on user input. In some embodiments, the listing logic circuit 118 is configured to monitor the offering prices of one or more products from multiple platform computing systems 150 over time. In some embodiments, the listing logic circuit 118 is configured to initiate the listing of a product on one or more platforms, such as, but not limited to, sending a listing request or sale command to the platform computing system 150. In one embodiment, the listing logic circuit 118 is configured to provide a user-selectable link to the user to transfer the user to a website associated with the platform computing system 150, and may transfer additional information to the platform computing system 150 with the link such as user shipping information or payment information. The listing logic circuit 118 may also be configured to respond to accepted bids on product listings and update inventory information. In some embodiments, the listing logic circuit 118, in response to receiving an accepted bid on a listing on a first platform computing system 150, is configured to communicate with a second platform computing system 150 to notify the second platform computing system of the accepted bid. Listing configurations associated with the listing logic circuit 118 will be discussed in subsequent detail below in regard to FIGS. 5 and 6.

The notification generator 120 is configured to notify an end user of relevant notifications, such as but not limited to, procurement opportunities, changes in procurement price to one or more products, and recent releases. The notification generator 120 may receive a notification message from the platform computing system 150 or from a client device that manually entered a notification. The notification generator 120 may be configured to transmit the notification message to one or more user computing devices 130 depending on the notification. The notification generator 120 may generate notifications that require, or make optional, a user input in response to the notification, such as a procurement acceptance response. Various interactions between the notification generator 120 and the user computing device 130 are discussed herein.

The GUI generator 114 is configured to generate a graphical user interface (GUI) for display to an end user. The GUI generator 114 may generate interfaces based on procurement and listing opportunities available from the one or more platform computing systems 150. In some embodiments, the GUI generator 114 is configured to generate a unique user interface for an end user based on the end user's searches, profile, inventory, or preferences. The generated GUI may include one or more interactive elements that receive user input. The GUI generator 114 transmit the generated GUI to the user computing device 130 for display. In some embodiments, the GUI generator 114 transmits data information for the UI display to the user computing device 130, and the user computing device 130 generates the GUI display. In some embodiments, the GUI generator 114 determines a type of device of the user computing device 130 and generates a UI configured particularly for the type of device.

With continued reference to FIG. 1, the application database 124 is a storage database for relevant product and procurement data associated with the automated procurement system 102 and/or user computing device 130. For example, the application database 124 may include data relating to universal product identifiers, product data (including prices, stock, metadata, etc.), identifiers for platform computing systems 150, user preferences and rules, and user inventory data. Although shown as a separate entity from automated procurement system 102, the application database 124 may also be implemented within the automated procurement system 102.

The user computing device 130 is a computing device associated with an end user, such as, but not limited to, a laptop, personal computer, smart phone, tablet, smart watch, or other computing device. The user device may generally have a processing circuit configured to interface with the networked system 100 via the network interface 134. The user computing device 130 is shown to include an input/output (I/O) interface 132. The I/O interface 132 is configured to receive input from the user via one or more buttons, keyboard, mouse, touchscreen, voice command, gesture, or other input means, and combinations thereof. The I/O interface 132 is also configured to output information to the user, such as, but not limited to, a display or a speaker. In some embodiments, some or all of the functions, features, or components as described in regards to the automated procurement system 102 are implemented by the user device 130.

The platform computing systems 150 are computer systems managed by platforms offering a plurality of products that are accessible to the automated procurement system 102. The platform computing systems comprise product data 154 corresponding to the available or offered products. Platforms corresponding to the platform computing systems 150 may be structure as a vendor (i.e., a seller offering goods to users of the platforms), or as a platform marketplace (i.e., allowing users to buy and sell goods from each other). The product data 154 may include price information 156, which may include current bid and/or ask data, and variation information 158, as well as other types of product data (e.g., sales history, future product releases, product metadata, etc.). The product data 154 may be organized in one or more data structures. The platform computing systems 150 may update the product data 154 periodically or continuously based on changes to offered products, variations, or prices. In some embodiments, the platform computing systems 150 are structured as servers in a client-server architecture, by which the automated procurement system 102 can request the product data 154. In some embodiments, the platform computing systems 150 provide application program interfaces (APIs) by which the automated procurement system 102 can request the product data 154.

The third-party computing systems 140 are computing systems connected to the networked system 100 that do not offer product assets but provide third-party data 144 that may relate to product assets offered by the platform computing systems 150. For example, the third-party computing systems 140 may be associated with entities such as, but not limited to, a third-party website, social media websites, news outlets, blogs, public databases, or product review websites. The third-party data 144 may be requested by the automated procurement system 102 and used by the threshold value generator 112 or the notification generator 120, for example, as will be described below.

Referring now to FIG. 2A, FIG. 2A depicts a sample product aggregation 202 of a product data for a Product X. Product X may be offered individually by Platform A (210), Platform B (220), and Platform C (230). Using a universal product identifier 203, the product aggregation 202 generally creates a mapping of Product X across the platforms 210, 220, and 230, which may be identified under different naming systems or coding systems on each platform. The product aggregation 202 may also include product metadata 204 which may pertain to generalized information about Product X (including, but not limited to, a product name, product number, manufacturer data, release date, total supply in circulation, sales history, and a product image). The product metadata 204 may be retrieved from one or more of the platform computing systems, from a third-party computing system, or entered manually by a client associated with the procurement system.

As shown in FIG. 2A, the platforms 210, 220, and 230 may each offer Product X under different sale arrangements. For example, Platforms 210 and 220 offer different prices for different variants of Product X, while Platform 230 offers the same price across variants. Platform 210 offers Product X as a platform marketplace, where users of the marketplace can make a bid offer to purchase Product X from a seller for a bid price, and providers can offer to sell Product X to a buyer at an asking or listing price. Thus, the price of Product X on platform 210 varies as the minimum asking price and the maximum bid price vary with supply and demand. Platform 220 is depicted as having a single price for each variant of the product. Such procurement scheme may keep prices fixed for allow prices to fluctuate. Finally, platform 230 is shown to also include inventory/stock information for each of the variants of the Product X. Such inventory considerations may be used in consideration of procurement thresholds or determination of product availability.

The product aggregation 202 is shown to aggregate the product data from the platforms 210, 220, and 230 as a pricing table 206. The pricing table 206 stores the optimal purchase price and selling price for each variant of the Product X, as well as a platform identifier to identify which platform offers the optimal purchase or selling price. The pricing table 206 may be updated periodically as the prices change on one or more platforms. In some embodiments, the pricing table 206 is updated after a predetermined period of time. In some embodiments, the pricing table 206 is updated in response to a price change notification received from one or more of the platforms 210, 220, or 230. A timestamp corresponding to the most recent update of the pricing table 206 may be stored in the product metadata 204. As would be appreciated, there may exist several methods and/or data structures to aggregate product data for the product aggregation 202.

Referring now to FIG. 2B, a method 240 is shown for communicating requests across a first platform computing system and a second platform computing system. The method 240 may be implemented by a procurement processing system, such as the automated procurement system 102. Although described in regards to two platforms, it should be appreciated that the method 240 may be implemented for more than two platform computing systems. The method 240 generally aggregates product data from the first platform computing system and the second platform computing system in association with a universal product identifier, and processes a request relating to the universal product identifier based on the received product data and communication with the platform computing systems.

At 242, product data corresponding to a first offering by the first platform is received from the first platform computing system and product data corresponding to a second offering by the second platform is received from the second platform computing system. As discussed above, the product data may comprise a platform-specific product identifier and pricing information for one or more variants of the products. The product data may be retrieved via individual data requests to the first and second platform computing systems, or may be included in a batch-request for product data. In some embodiments, the product data is maintained and periodically updated by the processing system is response to price change notifications sent by the platform computing systems.

At 244, the processing system determines a universal product identifier corresponding to the first offering and the second offering. The universal product identifier generally integrates the first offering and the second offering into a single, generic product object. The universal product identifier may also identify and/or further classify variations of the product offered by the platforms. For example, the product data for the first offering may specify one or more variants of the first offering, such as the available shoe sizes for a collectable shoe. The universal product identifier may thus be associated with variation data for the first offering (and similarly for the second offering) relating to available variations and variation-specific pricing. In one embodiment, the universal product identifier is determined by determining a product name for each of the first offering and the second offering correspond to a product name of the product. In one embodiment, the universal product identifier is determined based on a manufacturer product number of the first offering and the second offering. In some embodiments, the universal product identifier is structured within a data structure, and the data structure includes platform-specific identifiers for the first offering and the second offering.

At 246, the processing system receives a request relating to the universal product identifier. Because the universal product identifier integrates the first offering and the second offering, the request may be designated platform-agnostic. In some embodiments, the request is a request to procure a product corresponding to the universal product identifier from one or more of the platform computing systems. In some embodiments, the request is a request to list a product corresponding to the universal product identifier on one or more of the platform computing systems. The request may be received from a user via a user interface, or from an automated procurement process based on established procurement rules. In some embodiments, the request comprising rules governing how the request should be processed by the processing system, such as but not limited to, a minimum or maximum price for a procurement, timing parameters of when the request should be executed, a particular variant of the product, a particular platform of the plurality of platform computing systems, or combinations thereof.

At 248, the processing system determines a qualifying product of the first offering and the second offering based on the received request. In one embodiment, the qualifying product is determined based on which of the first offering and the second offering has a lower price. In one embodiment, the qualifying product is determined based on which of the first offering and the second offering has a higher listing price. In some embodiments, multiple offerings are determined to meet the requirements of a qualifying product based on the received request. Other considerations will be appreciated as discussed herein.

At 250, a communication is sent to the platform computing system corresponding to the qualifying product by the processing system. The communication comprises a command to facility the request, such as a procurement, bid, or listing command, for example. In one embodiment, the processing system, using the universal product identifier, determines a platform-specific identifier of the qualifying product, and includes the platform-specific identifier in the communication. In one embodiment, the processing system sends the communication to two or more platform processing systems. Thus, the processing system compiles product data into an aggregated platform via the method 240 to subsequently translate platform-agnostic requests into specific product requests that are executed across multiple platform computing systems. Various implementations of this and other communications will be discussed herein in reference to the other figures.

Referring now to FIG. 3, a method 300 is shown for facilitating communication of a procurement system for a procurement request of a product asset. The method 300 may be implemented by a processing system, such as the automated processing system 102. The method 300 may be implemented using compiled product data as discussed in regards to FIGS. 2A and 2B.

At 302, a request is received relating to the procurement of a product, the request specifying a variation of the product. The request may be received from a user via a user interface, or may be generated by an automated procurement system based on predetermined procurement rules. The variation may be a single variation or multiple acceptable variations. In some embodiments, the request may specify a variation for more than one product variable (e.g., if the product asset is a shoe, the request may specify a color and size of the shoe). The request may also include additional procurement criteria, such as but not limited to a procurement date or deadline, a maximum or minimum procurement price, one or more platforms to search, one or more platforms to exclude, or notification settings. In some embodiments, the request may specify to procurement more than one product assets of the specify product and variation.

At 304, product data corresponding to available products offered by platforms is received from one or more computing systems corresponding to the platforms. The product data may include price information, variation information, inventory information, product metadata, and sales history, for example. The product data may be retrieved by sending a specific request for product data corresponding to particular products offered by the platform, or may be retrieved in a batch request. In some embodiments, a processing system implementing the method 300 maintains product data over time and retrieves updates to the product data from the platform computing systems.

At 306, a threshold procurement value is determined by the processing system. In some embodiments, the processing system implementing method 300 determines the threshold procurement value based on relevant data corresponding to the product identified in the request and/or products similar to the product identified in the request. The processing system may identify relevant data by determining a product identifier of the product identified in the request. In some embodiments, the threshold procurement value is based on a user input received from a user interface. The threshold procurement value may also be structured as a threshold procurement range, specifying a maximum and minimum value.

At 308, a qualifying product is determined by the processing system, where the qualifying product is a product offered on the platform computing systems that satisfies the threshold procurement value. For example, the processing system may use the product data to identify one or more products that match the product and variation specified in the request, and select a product of the one or more products as the qualifying product responsive to the price of said product being less than or equal to the threshold procurement value. In some embodiments, multiple qualifying products may be identified based on the request criteria.

At 310, a communication is transmitted by the procurement processing system to initiate procurement of the qualifying product. In one embodiment, the procurement processing system sends a request to the platform computing system associated with the qualifying product to procure the product. In one embodiment, the platform computing system transmits a selectable link to the user via a user interface to direct the user to a procurement interface of the platform computing system. In one embodiment, the processing system sends a notification to the user via a user interface notifying the user of the qualifying product. The notification may include a request for the user to accept or deny procurement of the qualifying product.

In some embodiments of the method 300, the procurement processing system transmits a bid request to one or more of the platform computing systems, where the bid request specifies a request to place a bid to procure the product and variation at the threshold procurement value. The method 300 may then include receiving, from one platform computing system of the one or more platform computing systems, an indication of an accepted bid corresponding to the transmitted bid request. The product offered by the one platform corresponding to the accepted bid may then be considered the qualifying product. The method 300 may also include the step of transmitting, by the procurement processing system, a cancellation request to the remaining platform computing systems to which a bid request was sent (i.e., the platform computing systems that are not the platform computing system corresponding to the accepted bid), the cancellation request requesting the bid requests be cancelled on the remaining platforms. Thus, only a single product (or in the case when the request specifies the procurement of multiple products, the defined number of products) is procured by the user even though multiple bid requests were transmitted to multiple platforms.

In some embodiments, the procurement processing system is configured to request updates to the product data periodically over time to monitor product prices. None of the offered products may qualify as a qualifying product at the time of the procurement request; thus the procurement processing system may then monitor the prices until a qualifying product is determined. In some embodiments, the threshold procurement value is updated in periodic intervals to reflect changes to the underlying value of the specified product and variation in time.

Referring now to FIG. 4A, a flow diagram 400 of a procurement process is shown, according to one embodiment. The flow diagram 400 may comprise steps corresponding to steps in the method 300 as described above. The flow diagram 400 includes the user device 130, the procurement system 102, one or more of the platform computing systems 150, and one or more of the third-party computing systems 140. The flow diagram 400 generally illustrates the interaction of the user device 130 in generating and fulfilling a procurement request.

The user device 130 first sends a procurement request to the procurement system. The procurement request comprises a product and variation of the product to procure. The procurement request may be generated by the user device 130 in response to a user input on a user interface of the user device 130. The procurement system 102 may then transmit one or more requests to the platform computing systems 150 for product data, which is received back from the platform computing systems 150. The procurement system 102 may also request secondary data from the one or more platform computing systems 140 corresponding to the specified product or products similar to the specified product. The collected data may then be used by the procurement system 102 to determine a target price or threshold procurement value. If no product offered by the platform computing systems 150 satisfy the determined target price or threshold procurement value, the procurement system 102 may be configured to receive updates to prices and availability of products offered by the platform computing systems 150 until a qualifying product is identified.

Responsive to identifying a qualifying product that satisfies the procurement request, the procurement system 102 sends a notification to the user device 130 identifying the qualifying product and the associated platform of the qualifying product. The user device 130 then response to the notification with a confirmation (or alternatively, a denial) to procure the qualifying product. The procurement system 102 may then send a communication to the platform computing system 150 to initiate procurement of the product. The procurement system 102 may also updated inventory data of the user associated with the user device 130 to reflect the procurement of the qualifying product. For example, the procurement system 102 may manage a database of all product assets the user currently owns in an inventory database, and updating the inventory data may include the step of adding details of the qualifying product to the inventory database, such as but not limited to the procurement date, procurement price, procurement platform, and estimated arrival. The procurement system 102 may also send data to update the user interface of the user device 120 to reflect the updated inventory.

Referring to FIG. 4B, a flow diagram 425 of a multi-bid communication process is shown, according to one embodiment. The flow diagram 425 may comprise steps corresponding to steps in the method 300 as described above. The flow diagram 425 includes the user device 130, the procurement system 102, a first platform computing systems 150A, and a second platform computing system 150B. The flow diagram 425 generally illustrates the interaction of the user device 130 in generating and fulfilling a listing request. Although shown with only two platform computing systems 150A and 150B, the flow diagram 425 can be extended to include more platform computing systems.

The user device 130 first sends a procurement request to the procurement system 102, which designates a product and variation of the product to be acquired. Data regarding the designated product may be retrieved by the procurement system 102 from an inventory database of the user associated with the user device 130. The procurement system 102 then determines a procurement price, which may be determined based on data relating to the specified product, data relating to products similar to the specified product, user input, or combinations thereof. The procurement processing system 102 then sends a bid command to both the first platform computing system 150A and the second platform computing system 150B to place a bid for the specified product at the determined procurement price. Thus, multiple bids may be placed for procurement of a single product, the initial bid request thus gaining exposure to multiple markets simultaneously.

As depicted in the flow diagram 425, after a placed bid has been accepted by one of the platforms (here, the first platform computing system 150A), the platform computing system associated with said platform sends an indication of the accepted offer to the procurement system 102. The procurement system 102 then sends a notification to the user device 130 of the accept offer. The procurement system 102 also sends a cancellation message to the other platform computing systems (here, the second platform computing system 150B) to cancel the pending bid on the respective platforms without an accepted offer. The procurement system may then send a communication to the accepting platform computing system 150A to initiate or facilitate the procurement confirmation process. In embodiments where the procurement system 102 manages an inventory database of the user, the procurement system 102 may also update the inventory data in the inventory database to reflect the procurement of the particular product, such as but not limited to adding shipping information, a shipping deadline, or adding the product to the inventory database. Additionally, the procurement system 102 may send data to the user device 120 to update a user interface to reflect the addition of the product to the user inventory.

Referring now to FIG. 5, a method 500 is shown for facilitating communication between one or more platform computing systems in listing a product asset for sale. The method 500 may be implemented by a processing system, such as the automated processing system 102. The method 500 may be implemented using compiled product data in association with a universal product identifier as discussed in regards to FIGS. 2A and 2B.

At 502, a request is received to list a product for sale, the request specifying a variation of the product. The request may be received from a user via a user interface, or may be generated by an automated procurement system based on predetermined procurement rules. The variation may be a single variation or multiple acceptable variations. In some embodiments, the request may specify a variation for more than one product variable (e.g., if the product asset is a shoe, the request may specify a color and size of the shoe). In some embodiments, the product for listing in the listing request is identified from the user's inventory database, such as using an inventory number associated with the product in the inventory database. The request may also include additional listing criteria, such as but not limited to a listing date or deadline, a maximum or minimum listing price, one or more platforms to list the product, one or more platforms to exclude from the batch listing, or notification settings of the listing. In some embodiments, the request may specify to list more than one product asset of the specify product and variation.

At 504, the processing system determines a threshold listing value for the product. In some embodiments, the processing system implementing method 500 determines the threshold listing value based on relevant data corresponding to the product identified in the request or products similar to the product identified in the request. The processing system may identify relevant data by determining a universal product identifier of the product identified in the request. In some embodiments, the threshold listing value is based on a user input received from a user interface. The threshold listing value may also be structured as a threshold listing range, specifying a maximum and minimum value.

At 506, the processing system sends one or more listing commands to one or more platform computing systems based on the received listing request at 502. The listing command generally causes the platform computing systems to make available for sale the specified product and variation on the respective platform at the threshold listing value. Thus, in one embodiment, the listing request received at 502 causes the product to be offered for sale on multiple platform computing systems. The listing command may also include specific information regarding the identified product, such as user login or identification credentials, the particular platform identification number for the product, and the variant of the product for listing. In one embodiment, the listing request specifies the universal product identifier, and the processing system determines the product identification number specific to each platform using data stored in association with the universal product identifier. In response to the listing command, the one or more platform computing systems may transmit a listing identification number uniquely identifying the listed product on the particular platform.

At 508, an accepted offer of the listed product is received from a single platform of the one or more platform computing systems. The accepted offer indicates that a buyer has requested to procure the listed product at or above the threshold listing value.

At 510, the processing system transmits a cancellation communication to the remaining platform computing systems (i.e., the set of platform computing systems in the one or more platform computing systems to which a listing command was sent, where the set excludes the platform from which the accepted offer was received), the cancellation communication cancelling the offered listing of the product on the respective platform. Similar to the listing command, the cancellation communication may also include information regarding the listing product, such as user identification or login credentials and the listing identification number of the listed product.

At 512, a notification is transmitted to the user of the acceptance of the offered product on the single platform computing system. In some embodiments, the notification includes a prompt for the user to input confirmation of the sale of the listed product, and the procurement system is configured to transmit the confirmation to the single platform computing system of the accepted offer. In some embodiments, the notification includes a selectable-link in which the user may select via the interface to connect the user to a listing interface on the platform computing system to complete the sale of the listed product. In some embodiments, the notification includes information regarding the buyer, such as payment information, payment amount, or shipping location. In some embodiments, the notification includes policy guidelines required by the single platform, such as a platform fees related to the sale, shipping requirements, and general payment information.

Referring now to FIG. 6, a flow diagram 600 of a listing process is shown, according to one embodiment. The flow diagram 600 may comprise steps corresponding to steps in the method 500 as described above. The flow diagram 600 includes the user device 130, the procurement system 102, a first platform computing systems 150A, and a second platform computing system 150B. The flow diagram 600 generally illustrates the interaction of the user device 130 in generating and fulfilling a listing request. Although shown with only two platform computing systems 150A and 150B, the flow diagram 600 can be extended to include more platform computing systems.

The user device 130 first sends a listing request to the procurement system 102, which designates a product and variation of the product to be listed for sale. Data regarding the designated product may be retrieved by the procurement system 102 from an inventory database of the user associated with the user device 130. The procurement system 102 then determines the listing price, which may be determined based on data relating to the specified product, data relating to products similar to the specified product, user input, or combinations thereof. The procurement processing system 102 then sends a listing command to both the first platform computing system 150A and the second platform computing system 150B to list the specified product at the determined listing price. Thus, a product for sale can be exposed to multiple markets to improve the chances of being sold.

As depicted in the flow diagram 600, after a listing request has been accepted by one of the platforms (here, the first platform computing system 150A), the platform computing system associated with said platform sends an indication of the accepted offer to the procurement system 102. The procurement system 102 then sends a notification to the user device 130 of the accept offer. The procurement system 102 also sends a cancellation message to the other platform computing systems (here, the second platform computing system 150B) to cancel the pending listings on the respective platforms without an accepted offer. The procurement system may then send a communication to the accepting platform computing system 150A to initiate or facilitate the sale confirmation process. In embodiments where the procurement system 102 manages an inventory database of the user, the procurement system 102 may also update the inventory data in the inventory database to reflect the sale of the particular product, such as but not limited to adding shipping information, a shipping deadline, or removing the product from the database altogether. Additionally, the procurement system 102 may send data to the user device 120 to update a user interface to reflect the sale of the product from the user inventory.

Referring now to FIG. 7, a method 700 is shown for determining a threshold procurement value of a product asset, according to one embodiment. The method 700 may be implemented by a processing system, such as the automated processing system 102. The threshold procurement value may be a minimum listing price or a maximum procurement price, for example. The determined threshold value may be used as part of other methods discussed herein for improved facilitation of procurement or sale of the product designated by its universal product identifier.

At 702, association data identifying comparable items to a particular product is retrieved by the processing system. A comparable item may be a product within the same or similar category of products to the particular product. For example, if the particular product is a first model of shoe, a comparable product might be an earlier release or model of the same shoe line. The association data may be entered manually by a user or determined by the processing system by classifying products into product categories. The association data may be stored by the processing system or stored in a separate database.

At 704, the processing system retrieves pricing curves associated with the comparable items. A price curve may estimate the price of the comparable product against one or more variables, such as time, supply, demand, or variation of the product. The prices curves may be used to generate a statistical measure of the prices of the comparable items, such as an average price for a given condition, an average price curve of the comparable items, or other statistical metric.

At 706, production levels of the particular product are determined. The production levels may be determined based on manufacturer data retrieved from a third-party computing system. In some embodiments, the production levels are based on the number of unaccepted listings available across one or more of the platform computing systems. The production level may be a total number in supply, in circulation, or for sale. In some embodiments, the production levels are specified per each variation of the particular product or in aggregate for the particular product.

At 708, demand data is retrieved for the particular product. Demand data may be based on the number of unaccepted bids across one or more platform computing systems. In some embodiments, the demand data is based on the current procurement prices of the particular product. In some embodiments, the demand data is based on the number or size of a preorder list or backorder list. The demand data may be represented by an estimate of the total number of entities interested to procure the product at a given time.

At 710, opinion data of the particular product is retrieved by the processing system from third-party entities. In one embodiment, the opinion data is structure or unstructured data from a social media site. The opinion data may be analyzed to determine a general sentiment of the general population, or of a particular subgroup of the population, regarding the particular product. In some embodiments, the processing system retrieves opinion data from influencing or respected outlets, such as product testers, influencer pages, celebrities, or experts. The opinion data may be generated on a numeric scale ranging from favorable opinion (“positive”) to a negative opinion. In some embodiments, opinion data may also include the number of social media mentions (“how much activity”), the rate of said mentions (“how fast is activity”), and the duration of mentions (“how long”) on social media where the prodic is the topic of a discussion thread. A natural language processing algorithm may be used to identify positively-associated and negatively-associated words and phrases in the retrieved third-party data. In some embodiments, the opinion data is based on survey data performed by a third-party entity. Several other types and combinations of opinion data may be retrieved at 710.

At 712, a regression model is determined based on the data retrieved in steps 704-710. The regression model fits a prediction curve to the retrieved data from steps 704-710 to estimate the value of the particular product over time. In some embodiments, the regression model is a multi-variable regression model that fits the regression curve to more than one outcome variable. In some embodiments, the regression curve is specific to a particular variation of the particular product. The regression model may be periodically updated at fixed or dynamic intervals based on changes or additions to the input data from steps 704-710. In some embodiment, the regression model is updated responsive to a calculation of a threshold value. Although the method 700 is shown to include data sources 1-4, additional or fewer data sources may used in generating the regression model at 712.

At 714, a value of the particular product is estimated for a point in time using the regression model. In one embodiment, the point in time is the current moment, so as to estimate the value of the product in the current moment. In one embodiment, the point in time is when the value of the particular product will be at a maximum. Still in some embodiments, the user may designate a particular time in which to predict the value of the particular product. The predicted value of the product may then be used to determine whether the procurement or listing of the product will be profitable. For example, if the processing system determines that a listing offers the product for less than the current estimated value of the product, then the procurement would net a positive return. Likewise, if the value of the product is estimated to reach a maximum value at a particular point in the future, procurement of the product in the current moment may suggest a positive return on the investment.

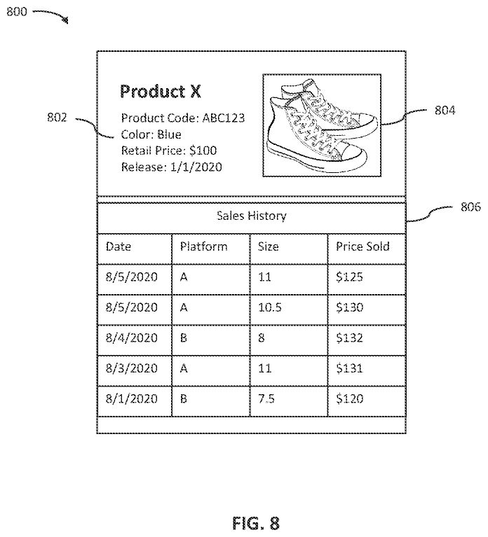

Referring now to FIG. 8, an example UI 800 is shown, according to one embodiment. UI 800 may be rendered by a user computing device, such as the user computing device 130, or by a central processing system such as automated procurement system 102. UI 800 may be generated in response to a user requesting data regarding a product identified by its universal product identifier. For example, a user may select Product X from a listing of several products supported by the procurement system. UI 800 is shown to include relevant product metadata 802, a product image 804, and sales history 806 for Product X. The sales history element 806 displays sales data for a product across multiple platforms, including sale date, sale price, sale platform, and sale variant (here, shown as size). As would be appreciated, the UI 800 is an illustrative example, and additional or fewer elements may also be included in UI 800 than those depicted here.

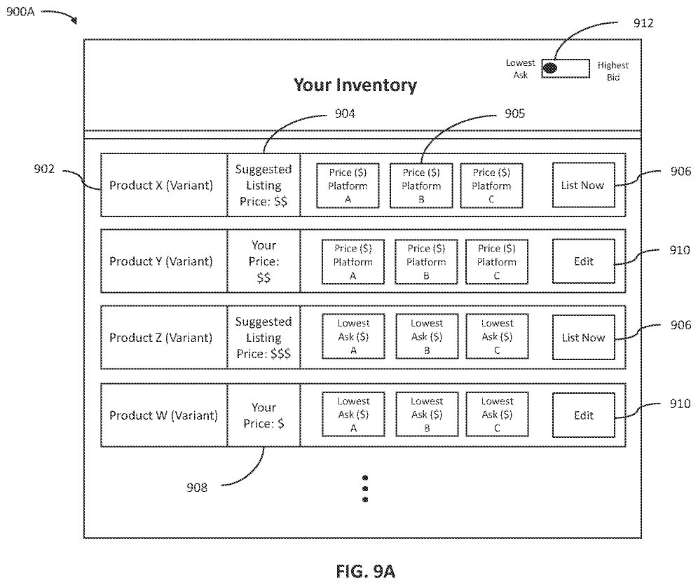

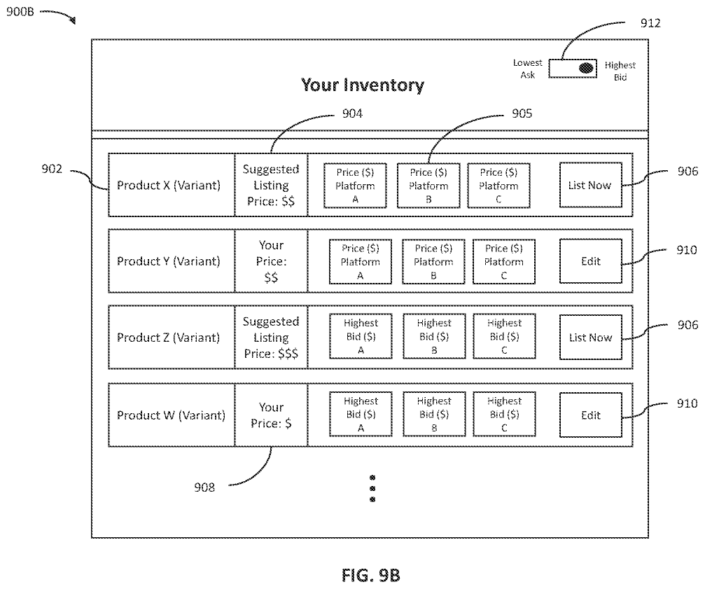

Referring now to FIG. 9A and FIG. 9B, example UIs 900A and 900B are shown, according to one embodiment. UIs 900A and 900B may be rendered by a user computing device, such as the user computing device 130, or by a central processing system such as automated procurement system 102. UIs 900A and 900B may be generated as part of an inventory management system to facilitate a user's management of product assets. As would be appreciated, the UIs 900A and 900B are illustrative examples, and additional or fewer elements may also be included in UIs 900A and 900B than those depicted here.

In some embodiments, the product assets displayed in UI 900A correspond to product assets currently owned by the user and stored in the user's inventory database. Graphical element 902 displays a particular product owned by the user, and may specify the variation of the product. In some embodiments, a suggested listing price may be generated by a processing system and displayed in association with the product as graphical element 904. The UI 900A may also include graphical elements 905 that display the current listing prices of the product in 902 on specific platforms. In some embodiments, the UI 900A may include one or more user-selectable buttons 906 to cause a processing system to list the particular product to one or more platform computing systems. In one embodiment, the suggested listing price is used in the listing request in response to the button 906 being selected. In one embodiment, the user can manually enter the listing price. The user may also be prompted to select which platforms on which to list the product. In some embodiments, UI 900A includes one or more user-selectable buttons 910 to edit an existing product listing or sale. The user-selectable button 910 may be structured to generate a graphical element to allow the user to, for example, change the asking price on one or more platforms, or delist the product from one or more platforms. The graphical element 908 may display the set asking price of the existing listing and/or the platforms on which the product has been listed.

In some embodiments, the procurement process for a product on one or more platforms may be structured as a bidding system in which the user may list the product for sale at an asking price to be bid on by other users. In these configurations, the user may be interested in both the highest bid price on a platform as well as the lowest asking price for the product. The UI 900A is thus shown to include a toggle switch 912 to switch between the UI 900A and UI 900B in FIG. 9B. The UI 900B can include any or all of the elements and functionality of UI 900A, and instead of showing the lowest asking price on each platform as shown in the UI 900A, the UI 900B may toggle the display to show the highest bid price for each platform. Thus, the UIs 900A and 900B allow the user to switch between different types of product data on each platform for inventory management.

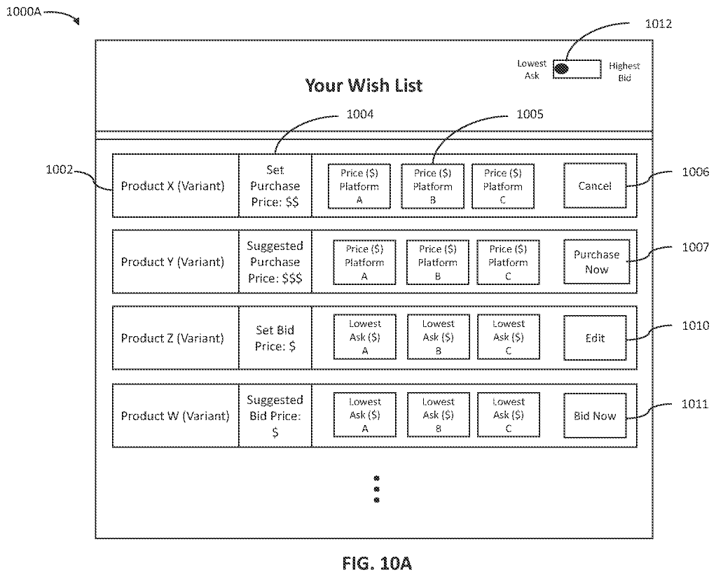

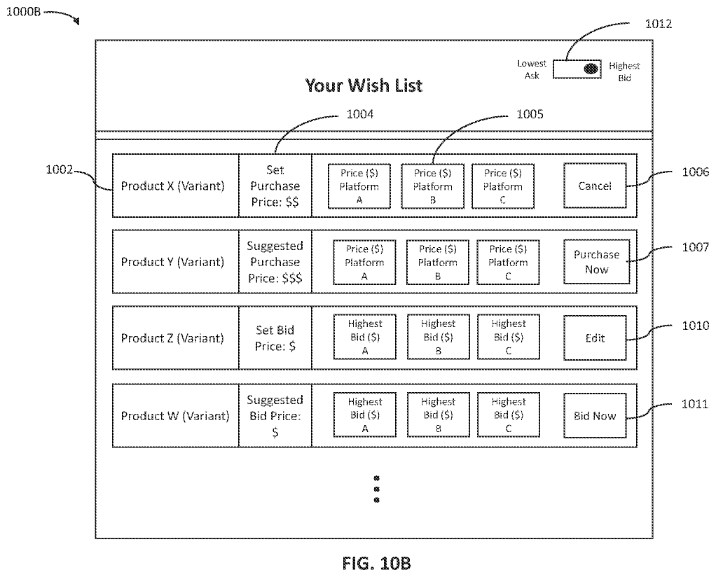

Referring now to FIGS. 10A and 10B, another set of example UIs 1000A and 1000B is shown, according to one embodiment. UIs 1000A and 1000B may be rendered by a user computing device, such as the user computing device 130, or by a central processing system such as automated procurement system 102. The UIs 1000A and 1000B may be generated as part of a procurement management system to facilitate the procurement of various product assets. As would be appreciated, the UIs 1000A and 1000B are illustrative examples, and additional or fewer elements may also be included in the UIs 1000A and 1000B than those depicted here.

In some embodiments, the UI 1000A may be a list of products the user has indicated interest in procuring. A graphical element 1002 corresponds to a particular product of said list of products and may specify the variation of the product the user indicated. In some embodiments, a graphical element 1004 is displayed in association with the graphical element 1002 to include a suggested or set procurement price of the product. UI 1000A may include one or more interactive elements, such as user-selectable buttons 1006, 1007, 1010, and 1011. In regards to button 1006, the user may have placed a procurement request or bid request for the Product X at the indicated price, and the button 1006 cancels the procurement request in response to the user selecting the button 1006. In regards to button 1007, the user may wish to procure the Product Y from a platform at the listed price, or may have received an accepted bid from a platform on a previous bid request at the indicated price. In response to the user selecting the button 1007, the processing system will transmit a communication to a particular platform to confirm the purchase agreement and facilitate procurement of the Product Y. For the button 1010, the user may have previously sent a bid request for the Product Z to one or more platforms, and in response to the selection of the button 1010, a graphical interface may be generated to edit the bid request to the one or more platforms, such as changing the bid price on one or more platforms or removing the bid from one or more platforms. In regards to the button 1011, the user may be prompted to bid at a recommended procurement threshold for a Product W, and in response to the selection of the button 1011, the processing system transmits a bid request to one or more platform computing systems for Product W.

As discussed in regards to FIGS. 9A and 9B, the procurement process for a product on one or more platforms may be structured as a bidding system in which the user may place a bid on a particular product to be accepted by a seller. In these configurations, the user may be interested in both the highest bid price on a platform as well as the lowest asking price for the product. The UI 1000A is thus shown to include a toggle switch 1012 to switch between the UI 1000A and UI 1000B in FIG. 10B. The UI 1000B can include any or all of the elements and functionality of UI 1000A, and instead of showing the lowest asking price on each platform as shown in the UI 1000A, the UI 1000B may toggle the display to show the highest bid price for each platform. As shown, the UIs 1000A and 1000B allow the user to switch between different types of product data on each platform for inventory management.

Thus, in one embodiment of the present disclosure, a method for integrating a first platform computing system and a second platform computing system is provided, the method comprising the steps of retrieving, by a processing system from the first platform computing system and the second platform computing system, product data corresponding to a first offering by the first platform computing system and a second offering by the second platform computing system; determining, by the processing system, a universal product identifier corresponding to the first offering and the second offering; receiving, by the processing system, a request relating to the universal product identifier; determining, by the processing system, a qualifying product of the first offering and the second offering, the qualifying product satisfying the received request; and transmitting, by the processing system to the platform computing system associated with the qualifying product, the request, the request identifying the qualifying product. In some embodiments, the request is a request to procure a product corresponding to the universal product identifier, and the qualifying product is the product with the lowest price across the platforms. In some embodiments, the request is a request to list a product on one of the platforms, where the one platform is chosen based on having the highest sale price. As would be appreciated, the request may specify a particular variation of the universal product identifier. In some embodiments, the processing system determines a threshold procurement value. In some embodiments, the threshold procurement value may be determined specific to the specified variation of the product or universal product identifier identified in the request.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A method for communicating between a first platform computing systems and one or more additional platform computing systems, the method comprising:
receiving, by a processing system, a request to list a product for sale, the request specifying a variation of the product;
transmitting, by the processing system, a listing request to the first platform computing system and the listing request to the one or more additional platform computing systems for the product having the specified variation of the product;
receiving, by the processing system from the first platform computing system, an indication of an accepted bid corresponding to the listing request; and
transmitting, by the processing system to the one or more additional platform computing systems, a cancellation request for the listing request at the one or more additional platform computing systems.

2. The method of claim 1, further comprising transmitting, by the processing system to a user device, a notification of the accepted bid on the first platform computing system.

3. The method of claim 1, wherein the listing request specifies a threshold listing value at which the product may be sold, wherein the accepted bid comprises a procurement price greater than or equal to the threshold listing value.

4. The method of claim 3, further comprising determining, by the processing system, the threshold listing value based on one or more of: supply data corresponding to the product, demand data corresponding to the product, product data corresponding to similar products comparable to the product, and opinion data corresponding to the product.

5. The method of claim 3, further comprising:
receiving, by the processing system prior to receiving the notification of the accepted bid, an updated threshold listing value; and
transmitting, by the processing system to the first platform computing system and the one or more additional platform computing systems, an update to the bid request comprising the updated threshold listing value, the update causing the threshold listing value to be replaced by the updated threshold listing value for the bid request.

6. An apparatus for integrating a first platform computing system and a second platform computing system, the apparatus comprising:
a network interface configured to communicate with the first platform computing system and a second platform computing system; and
a processing circuit comprising a processor and memory with instructions stored thereon that, when executed by the processor, cause the processor to:
receive a request to list a product for sale, the request specifying a variation of the product;
transmit, via the network interface, a listing request to the first platform computing system and the listing request to the second platform computing system for the product having the specified variation;
receive, from the first platform computing system via the network interface, an indication of an accepted bid corresponding to the listing request;
transmit, via the network interface to the second platform computing system, a cancellation request for the listing request at the second platform computing system; and
generate a notification of the accepted bid on the first platform computing system.

7. The apparatus of claim 6, further comprising an inventory database configured to store inventory data corresponding to one or more products of a user; wherein the processor is further configured to update the inventory database based on the accepted bid.

8. An apparatus for integrating a first platform computing system and a second platform computing system, the apparatus comprising:
a network interface configured to communicate with the first platform computing system and a second platform computing system; and
a processing circuit comprising a processor and memory with instructions stored thereon that, when executed by the processor, cause the processor to:
receive a request to procure a first product and receive a request to list a second product for sale, the request specifying a first variation for the first product and a second variation for the second product;
transmit, via the network interface, a bid request for a first product and a listing request for a second product to the first platform computing system, the first product having a first specified variation, and the second product having a second specified variation;
receive, from the first platform computing system via the network interface, an indication of an accepted bid corresponding to the bid request or the listing request;
transmit, via the network interface to the second platform computing system, a cancellation request for the accepted bid request or accepted listing request at the second platform computing system; and
generate a notification of the accepted bid on the first platform computing system.

9. The apparatus of claim 8, further comprising an inventory database configured to store inventory data corresponding to one or more products of a user; wherein the processor is further configured to update the inventory database based on the accepted bid.
